(19) United States
(12) Patent Application Publication
(10) Pub. No.: US 2010/0214583 A1
(43) Pub. Date: Aug. 26, 2010

(54) IMAGE READING APPARATUS AND CONTROL METHOD OF IMAGE READING APPARATUS

(75) Inventor: Junya Suga, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/711,149

(22) Filed: Feb. 23, 2010

(30) Foreign Application Priority Data
Feb. 25, 2009 (JP) 2009-041920

(51) Int. Cl. H04N 1/46; G06F 15/00

(52) U.S. Cl. 358/1.9; 358/505

(57) ABSTRACT

An image reading apparatus which performs a shading correction by using white reference data, includes an image sensor which transfers accumulated charge to a shift register by a shift pulse; a motor for moving a carriage; an encoder; and a shift pulse control unit, wherein in a white reference data acquisition process, the shift pulse control unit outputs a shift pulse which is a start timing of the charge accumulation corresponding to a predetermined reference color in a case in which an output result of the encoder is in a predetermined state, outputs a shift pulse which is a start timing of the charge accumulation corresponding to each color other than the predetermined reference color in a case in which a predetermined time for each color other than the predetermined reference color has elapsed from the start timing of the charge accumulation corresponding to the predetermined reference color as a reference.

### BACKGROUND

1. Technical Field

The present invention relates to an image reading apparatus and a control method of the image reading apparatus.

2. Related Art

JP-A-7-203201 discloses an example of an image reading apparatus such as a scanner device, which performs a shading correction prior to reading of a manuscript in order to prevent an unevenness of the reading image due to a variation in the light amount of light source lamp or an irregularity in the sensitivity of an image reading element and the like. With regard to the shading correction, a white reference plate equipped in the image reading apparatus is read and, on the basis of the read data (hereinafter, referred to as “white reference data”), a correction formula is created for every reading element.

In the image reading apparatus having a function of shading correction as described above, it is necessary to control the read timing of the white reference plate by an image sensor to be accurately matched with a position of a sensor module equipped with the image sensor in order to prevent a line missing and the like from being occurred in reading the white reference plate.

By the way, during a high speed movement of a carriage, the carriage passes through an acceleration region (acceleration period), a constant speed region (a constant speed (uniform speed) period) and a deceleration region (a deceleration period) from the start to end of the movement. In this case, for a stable reading, it is preferable to perform reading in the constant speed region.

However, if a width of the white reference plate is narrowed to reduce the size of the apparatus, the constant speed period is shortened. Accordingly, it is not possible to obtain the white reference data with high accuracy through the reading only in the constant speed period.

### SUMMARY

An advantage of some aspects of the invention is to provide a technique which obtains white reference data with high accuracy even if a width of the white reference plate is narrow.

According to a first aspect of the invention, there is provided an image reading apparatus which performs a shading correction by using white reference data, including: an image sensor which transfers the charge accumulated in a photoelectric conversion element to a shift register by a shift pulse; a motor for moving a carriage which carries the image sensor; an encoder which detects a rotation amount of the motor and outputs it; and a shift pulse control unit which controls an output timing of the shift pulse, wherein in a white reference data acquisition process of acquiring the white reference data, the shift pulse control unit outputs a shift pulse which is a start timing of the charge accumulation corresponding to a predetermined reference color in a case in which an output result of the encoder is in a predetermined state, outputs a shift pulse which is a start timing of the charge accumulation corresponding to each color other than the predetermined reference color in a case in which a predetermined time for each color other than the predetermined reference color has elapsed from the start timing of the charge accumulation corresponding to the predetermined reference color as a reference, and outputs a shift pulse further in a case in which the predetermined time has elapsed from the start timing of the charge accumulation corresponding to the predetermined reference color as a reference after the output of the shift pulse which is a start timing of the charge accumulation corresponding to each color other than the predetermined reference color.

Hereupon, in the image reading apparatus according to the first aspect of the invention, the shift pulse control unit performs the white reference data acquisition process over the entire periods including the acceleration period, the constant speed period and the deceleration period of the motor.

According to a second aspect of the invention, there is provided a control method of an image reading apparatus which performs a shading correction by using the white reference data, the apparatus comprising: an image sensor which transfers the charge accumulated in a photoelectric conversion element to a shift register by a shift pulse; a motor for moving a carriage which carries the image sensor; an encoder which detects a rotation amount of the motor and outputs it; and a shift pulse control unit which controls an output timing of the shift pulse, wherein in the white reference data acquisition process of acquiring the white reference data, the shift pulse control unit performs outputting a shift pulse which is a start timing of the charge accumulation corresponding to a predetermined reference color in a case in which an output result of the encoder is in a predetermined state, outputting a shift pulse which is a start timing of the charge accumulation corresponding to each color other than the predetermined reference color in a case in which a predetermined time for each color other than the predetermined reference color has elapsed from the start timing of the charge accumulation corresponding to the predetermined reference color as a reference, and outputting a shift pulse further in a case in which the predetermined time has elapsed from the start timing of the charge accumulation corresponding to the predetermined reference color as a reference after the output of the shift pulse which is a start timing of the charge accumulation corresponding to each color other than the predetermined reference color.

### BRIEF DESCRIPTION OF THE DRAWINGS

The invention will be described with reference to the accompanying drawings, wherein like reference numbers indicate like elements.

FIG. 1 is a view illustrating the schematic configuration of an image reading apparatus according to an embodiment of the invention.

FIG. 2 is an example of a timing chart of a control signal in a read control (4 shift control) of white reference data.

FIG. 3 is an example of a timing chart of a control signal in a read control (3 shift control) of white reference data according to the related art.

FIG. 4 is a flowchart focused on a kind of shift controls in a reading process performed by an image reading apparatus.

### DESCRIPTION OF EXEMPLARY EMBODIMENTS

Hereinafter, an embodiment of the invention will be described with reference to the accompanying drawings.

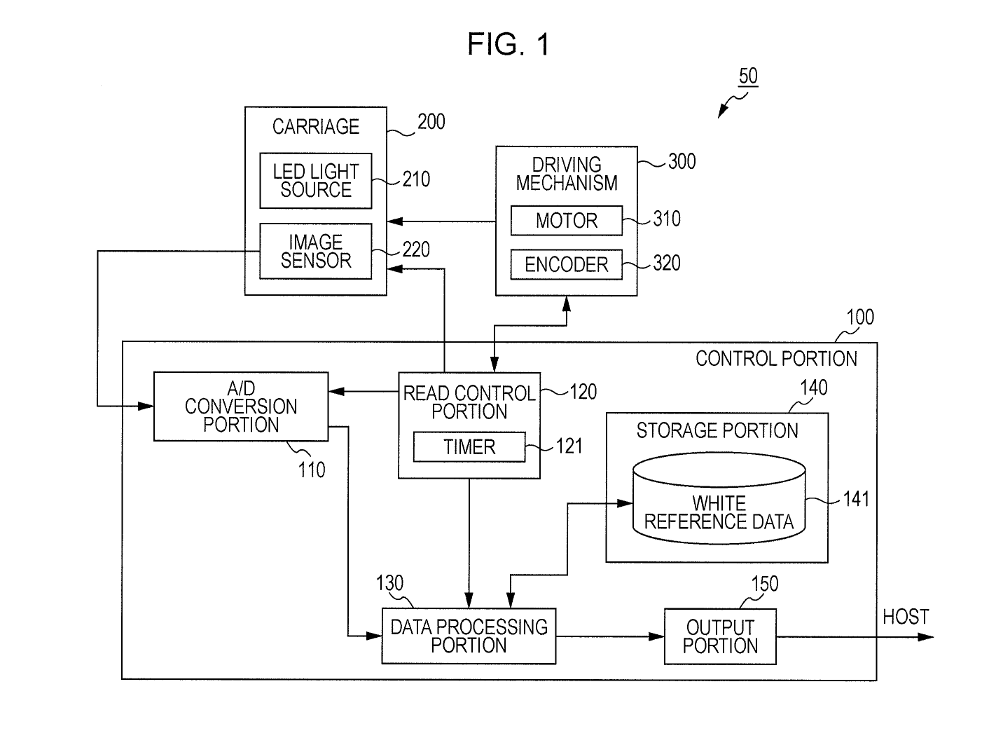

FIG. 1 is a view illustrating the schematic configuration of an image reading apparatus 50 to which an embodiment of the invention is applied.

The image reading apparatus 50 is a so-called flatbed type image reading apparatus in which a platen (not shown) is provided on an upper surface of a case. The image reading apparatus 50 reads an image of a manuscript placed on the platen, which is a transparent plate, by an image sensor 220.

In addition, the image reading apparatus 50 includes a mechanism for creating the white reference data used to perform a general shading correction. In this embodiment, the image reading apparatus 50 includes a white reference plate (not shown) which is a uniform reflecting surface with high reflectivity, on an upper surface of the case, as the mechanism for creating the white reference data. The image reading apparatus 50 light-emits (turns on) an LED light source 210 and reads the white reference plate by the image sensor 220.

Furthermore, although black reference data is also used for the general shading correction, the image reading apparatus 50 may not include a special mechanism for creating the black reference data. In case of creating the black reference data, the image reading apparatus 50 creates the black reference data for example by reading image data in a state where light-emitting of the LED light source 210 is stopped (turned off).

As shown, the image reading apparatus 50 includes a carriage 200 equipped with an LED light source 210 and the image sensor 220, a driving mechanism 300 which controls the movement of the carriage 200, and a control portion 100 which totally controls the image reading apparatus 50 and performs various processing for reading an image.

The carriage 200 carries the image sensor 220 together with the LED light source 210 in a sub-scanning direction. The carriage 200 is slidably attached to a guiding shaft and the like, which are parallel to a board surface of the platen, and is driven by a belt which rotates by a motor 310 (for example, a DC motor) of the driving mechanism 300. The movement amount of the carriage 200 is controlled on the basis of an output value of an encoder 320 that outputs an encoder pulse in accordance with the rotation amount of the motor 310 of the driving mechanism 300.

The LED light source 210 is formed by a red LED, a green LED, and a blue LED and emits RGB three color lights in a predetermined order. In this embodiment, the LED light source 210 emits the lights in an order of the red LED, the green LED and the blue LED in case of performing the reading of the white reference plate for one line. Then, in order to perform the reading of the white reference plate for several lines, the same light-emitting operation is repeated. A light-emitting time of each color LED is predetermined for every color. When the predetermined time has elapsed from the turning on, the LED is turned off.

Hereinafter, a color which firstly light-emits in a light-emitting operation for one line, among the RGB three colors, is called as a “reference color”. Furthermore, a light-emitting sequence is not limited to the order of RGB.

The image sensor 220 receives the light reflected from a manuscript, accumulates the charge according to the amount of light received, and transfers the charge to the control portion 100 as an image read data (electric signal).

The image sensor 220 is formed of a plurality of sensor chips arranged in a main scanning direction. Each sensor chip has the same configuration as a normal CCD (Charge Coupled Device) image sensor. That is, each sensor chip includes a photoelectric conversion element (a photodiode PD), a shift gate, and a shift register. Then, each sensor chip transfers the charge accumulated in the conversion element to the shift register by opening the shift gate, and outputs the charge while moving it sequentially by the shift register.

Opening of the shift gate (transfer of charge) is performed in response to application of the shift pulse (a signal from a read control portion 120 which will be described later). Hereupon, since the photoelectric conversion element always accumulates the charge according to the amount of light received, a timing at which the charge is transferred to the shift register becomes a start timing of the charge accumulation for the light of next light-emitting color. Then, the charge transferred to the shift register is converted to electric signal (analog data) by a terminal output portion of the shift register and sent to an A/D conversion portion 110.

The control portion 100 includes an A/D conversion portion 110 which converts analog data output from the image sensor 220 into digital data, a data processing portion 130 which performs various corrections on the digital data output from the A/D conversion portion 110, a storage portion 140 which stores the digital data on which various corrections are performed by the data processing portion 130, an output portion 150 which sends data from the data processing portion 130 to a host such as a personal computer, and a read control portion 120 which totally controls each of the functional portions in the control portion 100 and controls the LED light source 210 or the image sensor 220 in the carriage 200 and the driving mechanism 300.

Furthermore, the A/D conversion portion 110 may be mounted on a board in the carriage 200.

The read control portion 120 controls the movement of the carriage 200 by controlling rotation of the motor 310 of the driving mechanism 300.

In addition, the read control portion 120 controls an image reading of the image sensor 220, a reading of the white reference data and a reading of the black reference data. Specifically, with regard to the image sensor 220, the read control portion supplies a shift pulse to the image sensor 220 and controls a timing at which the charge accumulated in the photoelectric conversion element is transferred to the shift register (a start timing of next charge accumulation). In order to perform this control, the read control portion 120 includes a timer 121. Moreover, the read control portion 120 controls a transfer of the data read by the image sensor 220 to the A/D conversion portion 110.

In addition, the read control portion 120 also controls turning on/off of the LED light source 210 in accordance with the reading operation of the image sensor 220.

The data processing portion 130 performs various corrections such as a shading correction on the digital data output from the A/D conversion portion 110 and outputs the corrected digital data to the output portion 150. For example, in case of performing the shading correction, the data processing portion 130 stores the image data output from the A/D conversion portion 110, the white reference data and the black reference data in a storage portion 140 which will be described later, respectively, and performs a shading correction on every corresponding pixel according to a predetermined correction formula. After the correction, the data processing portion 130 outputs the corrected image data to the output portion 150.

The storage portion 140 stores the data on which various correction processing is performed by the data processing portion 130. Specifically, the storage portion 140 includes a white reference data DB (database) 141 which stores white reference data therein. In addition, the storage portion 140 may include an image data DB which stores image data prior to correction, or a black reference data DB which stores black reference data.

The output portion 150 includes an interface for performing a network connection or a USB connection and sends digital data output from the data processing portion 130 to a host computer.

Main components of the control portion 100 can be realized by a general computer including a main control unit CPU, a ROM on which program and the like is recorded, a RAM as a main memory which temporarily stores data and the like, an interface which controls input and output with regard to the host and the like, and a system bus which becomes a communication pathway between the components. They may be configured as ASIC (Application Specific Integrated Circuit) designed to perform each processing exclusively. The A/D conversion portion 110 may be configured as analog frontend IC (Integrated Circuit).

The image reading apparatus 50 to which this embodiment is applied is configured as described above. However, this configuration is to explain a main configuration for purposes of explaining the characteristics of the invention and the invention is not limited to such configuration. In addition, other configurations of a general image reading apparatus 50 are not excluded. Moreover, the image reading apparatus 50 may be a multifunction printer having additional printing or facsimile function.

In addition, each component as described above is classified according to its main processing content in order to facilitate understanding of the configuration of the image reading apparatus 50. The invention is not limited by a classifying manner or a name of the component. The image reading apparatus 50 (may) be configured such that it is classified into further more components according to processing content. In addition, it (may) be configured such that one component performs further more processing. Moreover, processing of each component may be performed by one hardware or plural hardware.

Next, a read control of white reference data performed in the read control portion 120 will be explained.

In the invention, the read control portion 120 controls reading of the white reference data by a 4 shift control which will be described later. Furthermore, in the invention, the read control portion 120 controls reading of the black reference data by a 3 shift control which will be described later. In addition, it controls reading of the image data of a manuscript by the 3 shift or the 4 shift control which will be described later.

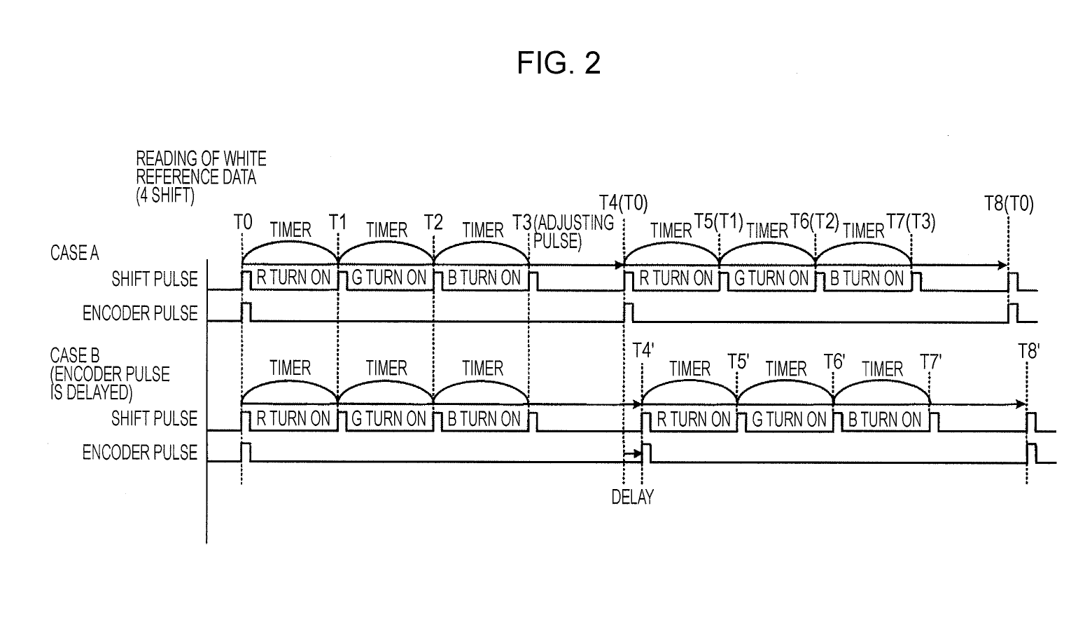

FIG. 2 is an example of a timing chart of a control signal in a read control (the 4 shift control) of the white reference data. Furthermore, the output timing of a shift pulse and an encoder pulse is not limited to the interval as shown.

As described above, it is required for the read control portion 120 to control the read timing of the white reference plate by the image sensor 220 to be accurately matched with a position of the carriage 200 equipped with the image sensor 220, in order to prevent a line missing and the like from being occurred in reading the white reference plate.

Thereupon, the read control portion 120 periodically determines a state of encoder pulse supplied from the encoder 320 by using the timer 121. Then, if the encoder pulse is in a predetermined state (for example, a High state), the read control portion outputs a shift pulse which becomes a start timing of the charge accumulation corresponding to a reference color (in a shown example, red color) to the sensor 220. Furthermore, this pulse indicates a transfer timing of the charge accumulated from the timing of an adjusting pulse which will be described later.

Therefore, as shown, a shift pulse starting the charge accumulation for a reference color so that a leading edge of encoder pulse being supplied from then encoder 320 is synchronized with a leading edge of the shift pulse being output to an image sensor 220 is output (case A: T0, T4 and T8; case B: T0, T4′ and T8′).

In addition, the read control portion 120 outputs the shift pulse which becomes a start timing of the charge accumulation corresponding to the colors other than the reference color (in a shown example, green color and blue color), which pulse becomes a pulse indicating a transfer timing of the charge for the previous color, at a constant timing (case A: T1, T2, T5 and T6; case B: T1, T2, T5′ and T6′) by using the timer 121 without depending on the state of encoder pulse. Furthermore, this pulse also indicates a transfer timing of the charge accumulated for the previous color (red color in case of green color, and green color in case of blue color).

For example, as shown, the shift pulse which becomes a start timing of the charge accumulation corresponding to green color (G) is output at a timing (T1) when “T1-T0” time has elapsed from the output (T0) of the shift pulse starting the charge accumulation for a reference color (R). In addition, the shift pulse which becomes a start timing of the charge accumulation corresponding to blue color (B) is output at a timing (T2) when “T2-T0” time has elapsed from the start (T0) of the charge accumulation for a reference color.

In addition, the read control portion 120 outputs an adjusting pulse at a constant timing (case A: T3, T7; case B: T3, T7′) by using the timer 121 after an output of the shift pulse corresponding to the final color among RGB colors (in a shown example, blue color). Moreover, this adjusting pulse also indicates a transfer timing of the charge accumulated for blue color.

For example, as shown, the read control portion 120 outputs an adjusting pulse at a timing (T3) when “T3-T0” time has elapsed from the start (T0) of the charge accumulation for a reference color after output of the shift pulse corresponding to blue color (B).

Furthermore, after output of the adjusting pulse, the charges in a predetermined period (case A: T4-T3, T8-T7; case B: T4′-T3, T8′-T7′) are transferred to a shift register at an output timing of next shift pulse (a shift pulse of a reference color), and then digital data corresponding to this charge are output to the data processing portion 130. However, since these digital data are unnecessary data, the data processing portion 130 discards these digital data and does not treat them as a read data. Of course, other functional portion may discard the digital data.

In addition, the read control portion 120 switches over the turning on/off of the LED light source 210 in accordance with an output timing of the shift pulse. However, at an output timing of the adjusting pulse, the read control portion 120 does not perform the turning on of the LED light source 210. In an example as shown, the read control portion 120 turns on a red LED in accordance with an output timing of the shift pulse which becomes a start timing of the charge accumulation corresponding to a red color (R), continues the turning on for a predetermined time, and then turns off it. Similarly, the read control portion turns on the multicolor LEDs (green LED and blue LED) in accordance with an output timing of the shift pulse which becomes a start timing of the charge accumulation corresponding to other colors (green color and blue color), continues the turning on for a predetermined time, and then turns off them.

Furthermore, the turn-on duration time of each color LED varies according to color. The reason is that since there is difference and variation in the brightness of the light source three colors and the sensitivity of sensor according to color, if the turn-on duration time is forced to be equal to each other, the photoelectric converted output charge amount of each color becomes different from each other. Accordingly, the turn-on duration time is previously set to be different according to the brightness of the light source three colors and the sensitivity of sensor.

By the way, the image read apparatus 50 according to the invention performs reading of the white reference plate over the entire periods of the motor 310 including the acceleration period, the constant speed period and the deceleration period in order to obtain the white reference data with high accuracy. However, due to the characteristics of a general motor, especially in a reading operation in the acceleration period and the deceleration period, the rotating speed of the motor 310 is not obtained as intended.

For example, there is a case in which the encoder pulse supplied from the encoder 320 is in an inexpectant state (for example, a Low state) (case B: T4′) at a timing when a shift pulse corresponding to the reference color should be output (case A: T4).

Thereupon, the read control portion 120 outputs an adjusting pulse next to the shift pulse corresponding to blue color (B), as described above. By this adjusting pulse, even in a case in which a leading edge of the encoder pulse is delayed (case B: T4′), it is possible to control the charge accumulation time for blue color to be a predetermined time “T3-T2”. Furthermore, as will described later, in case of 3 shift control which does not output the adjusting pulse, the charge accumulation corresponding to blue color is pursued in a state in which all of the LEDs are turned off, resulting in obtainment of only white reference data with low accuracy.

The above description is an explanation of the 4 shift control. Hereupon, in order to facilitate understanding, a read control of the white reference data according to the related art (3 shift control) will be explained.

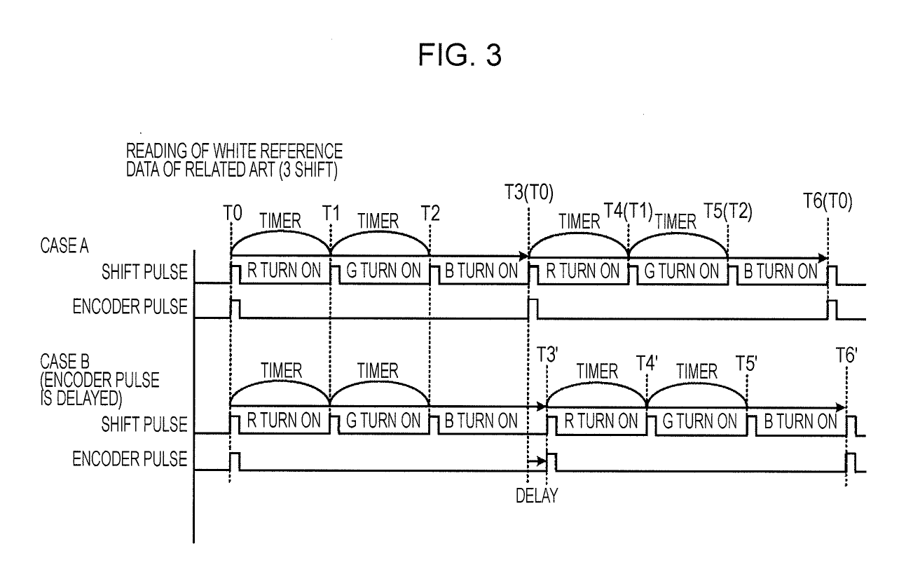

FIG. 3 is an example of a timing chart of a control signal in a read control (3 shift control) of white reference data according to the related art. Furthermore, an output timing of the shift pulse and the encoder pulse is not limited to the interval as shown.

The read control portion 120 periodically determines a state of encoder pulse supplied from the encoder 320 by using the timer 121. Then, if the encoder pulse is in a predetermined state (for example, a High state), the read control portion 120 outputs a shift pulse which becomes a start timing of the charge accumulation corresponding to a reference color (in a shown example, red color) to the image sensor 220.

Therefore, as shown, a shift pulse starting the charge accumulation for a reference color so that a leading edge of encoder pulse being supplied from then encoder 320 is synchronized with a leading edge of the shift pulse being output to an image sensor 220 is output (case A: T0, T3 and T6; case B: T0, T3′ and T6′).

In addition, the read control portion 120 outputs the shift pulse which becomes a start timing of the charge accumulation corresponding to the colors other than the reference color (in a shown example, green color and blue color) at a constant timing (case A: T1, T2, T4 and T5; case B: T1, T2, T4′ and T5′) by using the timer 121 without depending on the state of encoder pulse.

For example, as shown, the shift pulse which becomes a start timing of the charge accumulation corresponding to green color (G) is output at a timing (T1) when “T1-T0” time has elapsed from the output (T0) of the shift pulse starting the charge accumulation for a reference color (R). In addition, the shift pulse which becomes a start timing of the charge accumulation corresponding to blue color (B) is output at a timing (T2) when “T2-T0” time has elapsed from the start (T0) of the charge accumulation for a reference color.

In addition, the read control portion 120 does not output the above-described adjusting pulse after an output of the shift pulse corresponding to the final color among RGB colors (in a shown example, blue color). That is, if the encoder pulse is in a predetermined state (for example, a High state) after output of the shift pulse corresponding to blue color (B), the read control portion 120 outputs a shift pulse which becomes a start timing of the charge accumulation corresponding to a reference color to the image sensor 220.

Furthermore, description of a conversion control for the turning on/off of the LED light source 210 will be omitted since the conversion control is identical to the 4 shift control except for the adjusting pulse.

Hereupon, in case of performing the reading of the white reference data over the entire periods of the motor 310 including the acceleration period, the constant speed period and the deceleration period in order to read the white reference plate at high speed, for example, there is a case in which the encoder pulse supplied from the encoder 320 is in an inexpectant state (for example, a Low state) (case B: T3′) at a timing when a shift pulse corresponding to the reference color should be output (case A: T3).

Then, a charge accumulation corresponding to blue color is pursued in a state in which all of the LEDs are turned off even when a timing to output a shift pulse corresponding to reference color (case A: T3) has elapsed, resulting in obtainment of only the white reference data with low accuracy. Thereupon, the invention uses the above-described 4 shift control in reading the white reference data.

Next, a read processing performed by the image reading apparatus 50 will be explained.

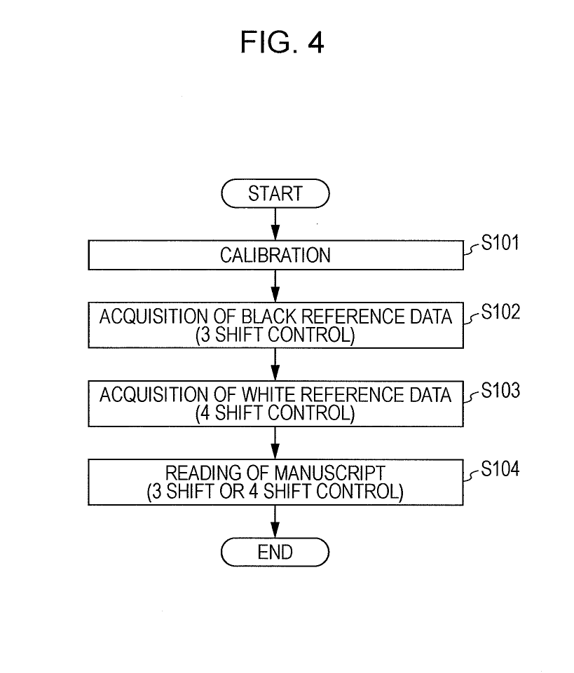

FIG. 4 is a flowchart focused on a kind of shift controls in a reading process performed by an image reading apparatus 50. This flow starts, for example, in a case in which the control portion 100 received a read instruction from a host.

In S101, the read control portion 120 performs a calibration. Specifically, the read control portion 120 adjusts the light amount of the LED light source 210 to be appropriate, or adjusts a gain value of an amplifier of the A/D conversion portion 110 so that the signal output from the image sensor 220 is appropriately amplified. Then, the read control portion 120 proceeds to the processing of S102.

In S102, the read control portion 120 acquires the black reference data. Specifically, the read control portion 120 performs reading of the black reference data while the motor 310 is stopped (the carriage is stationary), by the above-described 3 shift control. Furthermore, since the motor 310 is stopped, the read control portion 120 may make the shift pulse of the reference color explicit by using the timer 121 without depending on the state of the encoder pulse. Then, the read control portion 120 proceeds to a processing of S103.

In S103, the read control portion 120 acquires the white reference data. Specifically, the read control portion 120 drives the motor 310 (moves the carriage) and performs reading of the white reference data over the acceleration period, the constant speed period and the deceleration period by the above-described 4 shift control. Then, the read control portion 120 proceeds to a processing of S104.

In S104, the read control portion 120 performs reading of the manuscript. Specifically, the read control portion 120 drives the motor 310 (moves the carriage) and reads the image data of the manuscript by the above-described 3 shift control in a case in which a low-resolution reading is set and by the above-described 4 shift control in a case in which a high-resolution reading is set.

In the foregoing, one embodiment of the invention has been described. According to this embodiment, even in a case in which the white reference plate has a narrow width, it is possible to obtain the white reference data with high accuracy.

That is, according to this embodiment, the image reading apparatus 50 reads the white reference data by the 4 shift control. With such a configuration, it is possible to obtain the white reference data with high accuracy even in an acceleration period or a deceleration period of the motor 310. Accordingly, even in a case in which the white reference plate has a narrow width, it is possible to obtain a white reference data with high accuracy.

Furthermore, the above embodiment of the invention is intended to be exemplary of the gist and scope of the invention and is not to be considered as limiting. Various substitutions, modifications and variations are obvious to those skilled in the art.

What is claimed is:

1. An image reading apparatus which performs a shading correction by using white reference data, comprising:
an image sensor which transfers the charge accumulated in a photoelectric conversion element to a shift register by a shift pulse;
a motor for moving a carriage which carries the image sensor;
an encoder which detects a rotation amount of the motor and outputs it; and
a shift pulse control unit which controls an output timing of the shift pulse,
wherein in a white reference data acquisition process of acquiring the white reference data, the shift pulse control unit
outputs a shift pulse which is a start timing of the charge accumulation corresponding to a predetermined reference color in a case in which an output result of the encoder is in a predetermined state,
outputs a shift pulse which is a start timing of the charge accumulation corresponding to each color other than the predetermined reference color in a case in which a predetermined time for each color other than the predetermined reference color has elapsed from the start timing of the charge accumulation corresponding to the predetermined reference color as a reference, and
outputs a shift pulse further in a case in which the predetermined time has elapsed from the start timing of the charge accumulation corresponding to the predetermined reference color as a reference after the output of the shift pulse which is a start timing of the charge accumulation corresponding to each color other than the predetermined reference color.

2. The image reading apparatus according to claim 1, wherein,
the shift pulse control unit performs the white reference data acquisition process over the entire periods including the acceleration period, the constant speed period and the deceleration period of the motor.

3. A control method of an image reading apparatus which performs a shading correction by using white reference data, the apparatus comprising:
an image sensor which transfers the charge accumulated in a photoelectric conversion element to a shift register by a shift pulse;
a motor for moving a carriage which carries the image sensor;
an encoder which detects a rotation amount of the motor and outputs it; and
a shift pulse control unit which controls an output timing of the shift pulse,
wherein in a white reference data acquisition process of acquiring the white reference data, the shift pulse control unit performs
outputting a shift pulse which is a start timing of the charge accumulation corresponding to a predetermined reference color in a case in which an output result of the encoder is in a predetermined state,
outputting a shift pulse which is a start timing of the charge accumulation corresponding to each color other than the predetermined reference color in a case in which a predetermined time for each color other than the predetermined reference color has elapsed from the start timing of the charge accumulation corresponding to the predetermined reference color as a reference, and
outputting a shift pulse further in a case in which the predetermined time has elapsed from the start timing of the charge accumulation corresponding to the predetermined reference color as a reference after the output of the shift pulse which is a start timing of the charge accumulation corresponding to each color other than the predetermined reference color.
